(19) United States
(12) Patent Application Publication
(10) Pub. No.: US 2015/0340896 A1
(43) Pub. Date: Nov. 26, 2015

(54) POWER GENERATION CONTROL DEVICE

(71) Applicant: SANKEN ELECTRIC CO., LTD., Niiza-Shi (JP)

(72) Inventors: Ken KOJIMA, Fujimi-Shi (JP); Masahira KURIHARA, Edinburgh (GB)

(21) Appl. No.: 14/694,068

(22) Filed: Apr. 23, 2015

(30) Foreign Application Priority Data
May 22, 2014 (JP) 2014-105764

(51) Int. Cl. H02J 7/00; H05B 33/08

(52) U.S. Cl. CPC H02J 7/0052; H05B 33/0809

(57) ABSTRACT

A power generation control device is provided for controlling a power generator that charges a battery. The device includes a light-emitting diode having a first terminal connected to the battery, an internal power supply activation circuit that activates an internal power supply circuit, a light-emitting diode drive circuit connected to a second terminal of the light-emitting diode, the light-emitting diode drive circuit drives the light-emitting diode in accordance with a power generation state of the power generator, and an impedance conversion circuit that controls in such a manner that an impedance of the internal power supply activation circuit is higher when the light-emitting diode driven by the light-emitting diode circuit is turned off than when the light-emitting diode is turned on.

### CROSS REFERENCE TO RELATED APPLICATIONS

This application claims priority based on 35 USC 119 from prior Japanese Patent Application No. 2014-105764 filed on May 22, 2014, entitled “POWER GENERATION CONTROL DEVICE”, the entire contents of which are hereby incorporated by reference.

### BACKGROUND

The disclosure relates to a power generation control device that controls the power generation by a power generator mounted on, such as a vehicle. Particularly, the disclosure relates to controlling of a light-emitting diode (LED) used in a power generation control device.

A power generation control device is known which controls the power generation by a power generator for vehicle (for example, Japanese Patent Application Publication No. 2002-125329 (Patent Literature 1)). The power generation control device includes a power generation controller that controls a power generator, and a power generation detector that detects a power generation state of the power generator.

Conventional power generation control device includes a light to display the power generation state and a driving circuit of the light. According to Patent literature 1, disclosed power generation control device prevents erroneous lighting of the lamp by a current cutoff circuit in the drive circuit of the light. However, erroneous lighting could happen by smaller current if a light-emitting diode is used as the light. Therefore, further developments are desirable that erroneous lighting is prevented even when using a light-emitting diode.

### SUMMARY

An embodiment of power generation control device for controlling a power generator that charges a battery comprises a light-emitting diode having a first terminal connected to the battery, an internal power supply activation circuit that activates an internal power supply circuit, a light-emitting diode drive circuit connected to a second terminal of the light-emitting diode, the light-emitting diode drive circuit drives the light-emitting diode in accordance with a power generation state of the power generator, and an impedance conversion circuit that controls in such a manner that an impedance of the internal power supply activation circuit is higher when the light-emitting diode driven by the light-emitting diode circuit is turned off than when the light-emitting diode is turned on.

### BRIEF DESCRIPTION OF THE DRAWINGS

FIG. 1 is a circuit diagram for illustrating a configuration of a power generation detector used in a power generation control device according to example 1.

FIG. 2 is a circuit diagram for illustrating a configuration of a power generation detector used in a power generation control device according to example 2.

FIG. 3 is a diagram for illustrating current flows when an LED is turned on in the power generation control device according to example 2.

FIG. 4 is a diagram for illustrating current flows when the LED is turned off in the power generation control device according to example 2.

### DETAILED DESCRIPTION OF EMBODIMENTS

Hereinafter, power generation detectors used in a power generation control device according to embodiments are described in detail with reference to the drawings.

### Example 1

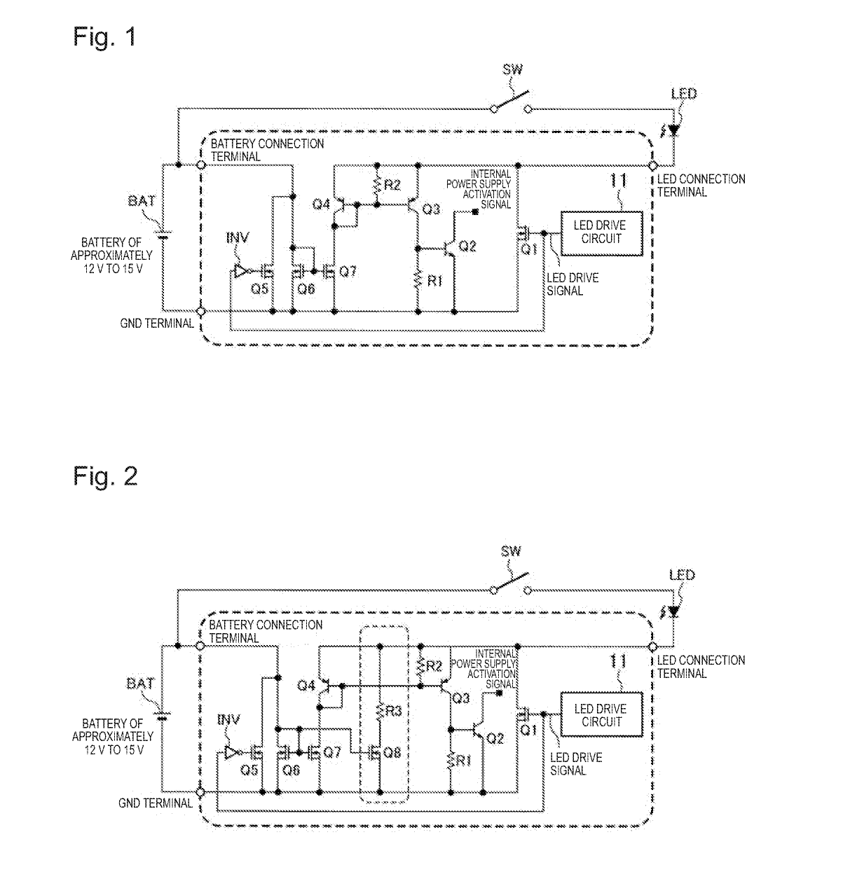

FIG. 1 is a circuit diagram illustrating a configuration of a power generation detector used in a power generation control device according to example 1.

The power generation detector is an IC including, for example, a battery connection terminal, a ground (GND) terminal, and an LED connection terminal. Battery BAT of approximately 12 V to 15 V is connected between the battery connection terminal and the GND terminal. Light-emitting diode LED is connected between the LED connection terminal and the battery connection terminal.

The power generation detector includes LED drive circuit 11 that controls on- and off-states of light-emitting diode LED, transistor Q1 is a MOSFET for driving LED, and an internal power supply activation circuit that activates an unillustrated internal power supply circuit.

The power generation detector may be an integrated Circuit (IC) comprising, for example, a battery connection terminal, a ground (GND) terminal, and a light-emitting diode (LED) connection terminal. Battery BAT of approximately 12 V to 15 V is connected between the battery connection terminal and the GND terminal. Light-emitting diode LED is connected between the battery connection terminal and the LED connection terminal through key switch SW.

The power generation detector includes LED drive circuit 11, transistors Q1 to Q7, inverter INV, and resistors R1 and R2. Transistors Q2 to Q7 and resistors R1 and R2 correspond to an internal power supply activation circuit. The internal power supply activation circuit that activates the internal power supply circuit in accordance with an operation mode of the power generation control device.

LED drive circuit 11 generates a LED drive signal in accordance with a power generation state of an unillustrated power generator, and then sends the signal to a gate of transistor Q1 and inverter INV. Such an LED drive signal is at an H level when light-emitting diode LED is turned on, and at an L level when light-emitting diode LED is turned off.

Transistor Q1 comprises an N type MOSFET, and is arranged between the LED connection terminal and the GND terminal. The gate of transistor Q1 receives an LED drive signal from LED drive circuit 11. Note that a driver in the embodiment comprises transistor Q1 and LED drive circuit 11.

Transistor Q2 comprises an NPN type transistor, and has an emitter connected to the GND terminal, a collector connected to an internal power supply circuit (unillustrated), and a base connected to the GND terminal through resistor R1 and also connected to a collector of transistor Q3. A signal of the collector of transistor Q2 is sent as an internal power supply activation signal to the unillustrated internal power supply circuit.

Transistor Q3 and transistor Q4 each comprises a PNP type transistor, and forms a current mirror circuit. Transistor Q3 has an emitter connected to the LED connection terminal, a collector connected to the base of transistor Q2, and a base connected to the LED connection terminal through resistor R2 and also connected to a base of transistor Q4.

Transistor Q4 has an emitter connected to the LED connection terminal, a collector connected to a drain of transistor Q7, and the base connected to the collector and the base of transistor Q2.

Transistor Q5 comprises an N type MOSFET, and is arranged between the battery connection terminal and the GND terminal. Inverter INV inverts an LED drive signal from LED drive circuit 11, and a gate of transistor Q5 that receives the resulting signal. Transistor Q5 and inverter INV correspond to an impedance converter and a first switch unit in this example.

Transistor Q5 and inverter INV perform control in such a manner that an impedance of the internal power supply activation circuit is higher when light-emitting diode LED is turned off than when light-emitting diode LED is turned on.

Transistor Q6 and transistor Q7 each comprise an N type MOSFET, and forms a current mirror circuit. Transistor Q6 has a drain connected to the battery connection terminal, a source connected to the GND terminal, and a gate connected to the drain and also connected to a gate of transistor Q7. Transistor Q7 has the drain connected to the collector of transistor Q4, a source connected to the GND terminal, and the gate connected to the gate of transistor Q6.

Next, description is given of the operation of the power generation detector used in the power generation control device according to example 1. In the power generation detector, transistor Q5 is provided as a switch between the battery connection terminal and the GND terminal. Transistor Q5 is driven by a signal obtained by inverting by inverter INV an LED drive signal from LED drive circuit 11.

When key switch SW is turned on during a sleep mode, the power generation control device is activated and switches to an operation mode. In a state where light-emitting diode LED should be turned on during the operation mode, LED drive circuit 11 outputs an LED drive signal at an H level.

Thereby, transistor Q1 is turned on, and a current flows through the following current path: battery BAT→key switch SW→light-emitting diode LED→the LED connection terminal→transistor Q1→the GND terminal. Thus, light-emitting diode LED is turned on.

Meanwhile, the LED drive signal from LED drive circuit 11 is inverted by inverter INV and applied to the gate of transistor Q5. Thereby, transistor Q5 is turned off. The current from battery BAT inputted through the battery connection terminal flows as an input current into transistor Q6 of the current mirror circuit. As a result, an output current flows into transistor Q7. This turns into an input current to transistor Q4, and an output current flows into transistor Q3. This output current flows into the GND terminal via resistor R1. Thereby, transistor Q2 is turned on, generating an internal power supply activation signal.

On the other hand, in a state where light-emitting diode LED should be turned off during the operation mode, LED drive circuit 11 supplies an LED drive signal at an L level to the gate of transistor Q1. Thereby, transistor Q1 is turned off, blocking the above-described current path. Meanwhile, the LED drive signal at the L level outputted from LED drive circuit 11 is inverted by inverter INV and applied to the gate of transistor Q5.

Thereby, transistor Q5 is turned on, and a current flows from battery BAT. As a result, the current mirror circuit comprises transistors Q6, Q7 is turned off, so that transistors Q3, Q4 are also turned off. The impedance between the LED connection terminal and the GND terminal is increased, blocking the current path. In other words, the impedance of the internal power supply activation circuit is higher when light-emitting diode LED is turned off than when light-emitting diode LED is turned on.

In this manner, according to example 1, in the state where light-emitting diode LED should be turned off after the power generation detector is activated and switches to the operation mode, the flow path of a leak current of light-emitting diode LED is blocked, hence making it possible to prevent erroneous light emission (very small light emission).

Moreover, according to example 1, the impedance between the LED connection terminal and the GND terminal is higher when the power generation by the power generator is normal than when the power generation is abnormal. This makes it possible to reduce the power consumption in the power generation detector.

### Example 2

Example 2 is to prevent an erroneous activation due to a surge application when a power generation detector that controls a power generator is in a sleep mode.

FIG. 2 is a circuit diagram for illustrating a configuration of a power generation detector used in a power generation control device according to example 2. This power generation detector is one obtained by adding a series circuit between the LED connection terminal and the GND terminal of the power generation detector according to example 1, the series circuit comprises resistor R3 and transistor Q8 as a switch.

In example 2, a multi-output type current mirror circuit is formed in which flowing an input current through transistor Q6 thereby flows an output current through transistors Q7, Q8. The series circuit comprises resistor R3 and transistor Q8 corresponds to an impedance converter and a second switch unit in this example.

In the power generation detector of example 2, when the power generation control device is in a sleep mode, LED drive circuit 11 and inverter INV are in an idle state, so that transistor Q5 is in an off-state. Nevertheless, even when the power generation control device is in the sleep mode, since a voltage from battery BAT is always applied to bases of transistors Q6 to Q8 which the current mirror circuit comprises, only the current mirror circuit is in an operation state, that is, in a low-impedance state capable of drawing a current.

In this case, the series circuit comprises resistor R3 and transistor Q8 lowers the impedance between the LED connection terminal and the GND terminal. Hence, even if a surge is applied from the outside through the LED connection terminal, the surge is absorbed to the ground and does not result in a voltage that drives transistor Q2. As a result, such an erroneous operation that the internal power supply activation circuit erroneously activates the internal power supply circuit is prevented.

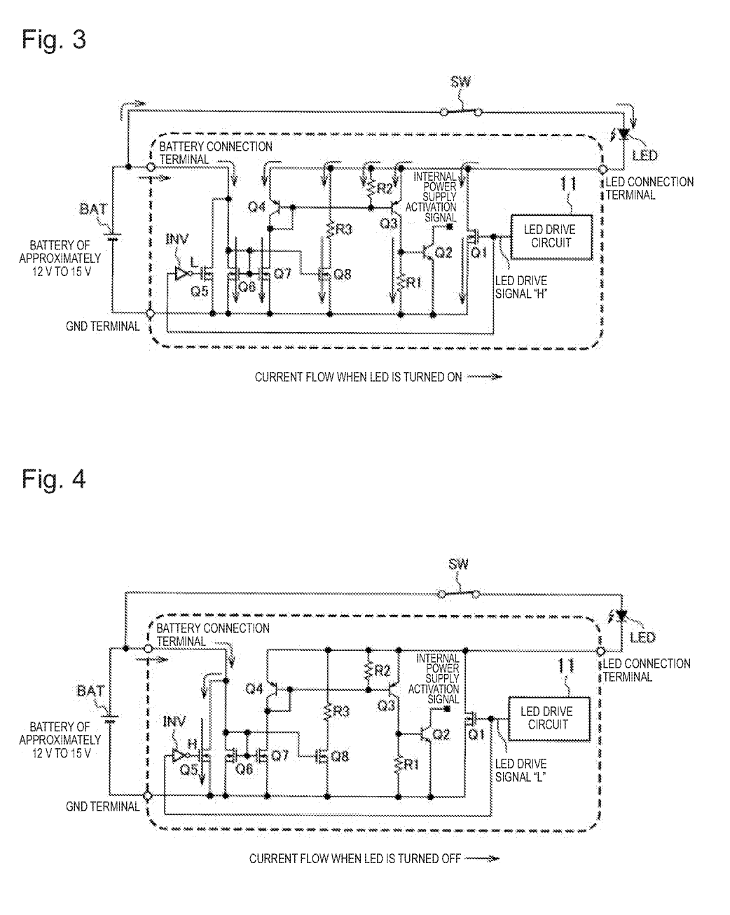

In FIG. 3, the arrows indicate current flows when light-emitting diode LED is turned on. When an LED drive signal from LED drive circuit 11 is at an H level and transistor Q1 for driving LED is turned on, a current flows in the following path: battery BAT→key switch SW→light-emitting diode LED→the LED connection terminal→transistor Q1→the GND terminal. Thus, light-emitting diode LED is turned on.

Meanwhile, the LED drive signal from LED drive circuit 11 is inverted by inverter INV and applied to the gate of transistor Q5. Thereby, transistor Q5 is turned off. The current from battery BAT inputted through the battery connection terminal flows as an input current into transistor Q6 of the current mirror circuit. As a result, an output current flows into transistor Q7. This turns into an input current to transistor Q4, and an output current flows into transistor Q3. This output current flows into the GND terminal via resistor R1. Thereby, transistor Q2 is turned on, generating an internal power supply activation signal.

In FIG. 4, the arrows indicate current flows when light-emitting diode LED is turned off. When an LED drive signal from LED drive circuit 11 is at an L level and transistor Q1 for driving LED is turned off, the current path from light-emitting diode LED to the GND terminal via the LED connection terminal and transistor Q1 is blocked, and light-emitting diode LED is turned off.

Meanwhile, the LED drive signal from LED drive circuit 11 is inverted by inverter INV and applied to the gate of transistor Q5. Thereby, transistor Q5 is turned on, and the current from battery BAT inputted through the battery connection terminal flows into the GND terminal via transistor Q5.

As a result, the current mirror circuit is turned off. This increases the impedance between the LED connection terminal and the GND terminal, and there is no longer a path for a current flowing into light-emitting diode LED, so that light-emitting diode LED is not turned on. Thus, it is possible to prevent light-emitting diode LED from being erroneously turned on.

In this manner, according to example 2, when key switch SW is turned off and the internal power supply circuit is in a sleep mode, if a surge is applied to the LED connection terminal due to an outside noise, there is a concern that an internal power supply activation signal may be erroneously outputted by operations of the internal power supply activation circuit. This concern is increased as the impedance of the internal power supply activation circuit is increased. Nonetheless, when an LED drive signal from LED drive circuit 11 is at an L level, for example, when the internal power supply circuit is in a sleep mode, the reliability of the power generation control device can be enhanced by decreasing the impedance between the LED connection terminal and the GND terminal.

In the above-described related art, in both cases where the light-emitting diode is turned on and turned off, a current of approximately several mA always flows into the internal power supply activation circuit. For this reason, even in a situation where light-emitting diode LED should be turned off, a current of approximately several mA flows into the light-emitting diode, so that very small light is emitted. This brings about a problem that light is erroneously emitted.

According to the above-described examples, the control is performed in such a manner that the impedance of the internal power supply activation circuit is higher when the light-emitting diode is turned off than when the light-emitting diode is turned on. Accordingly, it is possible to suppress the flow of a minute current when the internal power supply activation circuit is turned off. As a result, the light-emitting diode can be prevented from being erroneously turned on.

The embodiment is applicable to controlling for strictly turning on or turning off a light-emitting diode provided to various devices having a sleep mode and an operation mode.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A power generation control device for controlling a power generator that charges a battery, comprising:
a light-emitting diode having a first terminal connected to the battery;
an internal power supply activation circuit that activates an internal power supply circuit;
a light-emitting diode drive circuit connected to a second terminal of the light-emitting diode, the light-emitting diode drive circuit drives the light-emitting diode in accordance with a power generation state of the power generator; and
an impedance conversion circuit that controls in such a manner that an impedance of the internal power supply activation circuit is higher when the light-emitting diode driven by the light-emitting diode circuit is turned off than when the light-emitting diode is turned on.

2. The power generation control device of claim 1, wherein the impedance conversion circuit is arranged in parallel to the battery.

3. The power generation control device of claim 2, wherein the impedance conversion circuit comprises a first switch circuit that
passes therethrough a current from the battery to decrease the impedance of the internal power supply activation circuit when the light-emitting diode driven by the light-emitting diode drive circuit is turned on, and
blocks the current from the battery to increase the impedance of the internal power supply activation circuit when the light-emitting diode is turned off.

4. The power generation control device of claim 2, wherein the impedance conversion circuit further comprises a second switch circuit connected to the second terminal of the light-emitting diode, the impedance conversion circuit controls in such a manner as to decrease the impedance of the internal power supply activation circuit during a sleep mode.
